(19) United States
(12) Patent Application Publication
(10) Pub. No.: US 2008/0147489 A1
(43) Pub. Date: Jun. 19, 2008

(54) PROMOTIONAL PACKAGING AND METHOD FOR PRODUCING SAME

(75) Inventors: John E. GROMAN, Dover, MA (US); Allison SWAN, Arcadia, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Allison SWAN, Arcardia, CA (US)

(21) Appl. No.: 12/016,974

(22) Filed: Jan. 18, 2008

Related U.S. Application Data
(63) Continuation-in-part of application No. 11/105,266, filed on Apr. 13, 2005, now abandoned.
Application No. 11/105,266 is a continuation-in-part of application No. 11/059,142, filed on Feb. 15, 2005, now abandoned.

(51) Int. Cl. G06Q 30/00; G06Q 90/00

(52) U.S. Cl. 705/10

(57) ABSTRACT

A method of delivering preferred consumable products to a first person is provided. The method includes the steps of providing the first person with a preference worksheet that includes at least two preference choices, directing the first person to choose at least two preference choices on the preference worksheet, determining at least one consumable product that will fulfill the first person's preferences based on the at least two choices, packaging the at least one consumable product in a first portion of an enclosure, packaging an item having indicia printed on a first surface thereof in a second portion of the enclosure to form a promotional package, and delivering the promotional package to the first person. In a preferred embodiment, the method includes directing the first person to rate substantially all of the preference choices on the preference worksheet.

### RELATED APPLICATION

This application is a continuation-in-part of U.S. application Ser. No. 11/105,266 filed Apr. 13, 2005, which is a continuation-in-part of application Ser. No. 11/059,142, filed on Feb. 15, 2005, the entireties of each are incorporated herein by reference.

### FIELD OF THE INVENTION

The present invention relates generally to packaging, and more particularly, to a method and apparatus for promotional packages.

### BACKGROUND OF THE INVENTION

Cards, brochures and other printed media are typically used for promoting an event or product. In many instances, an inexpensive “giveaway” product, sometimes referred to in the marketing industry as a “tchotchke,” is also given away. However, the printed media usually become separated from the promotional product easily and thus are lost quite readily. In other instances, the recipient may just dispose of the advertising and keep the product. Adhesive may be used to attach the printed media to the giveaway product, the printed media is still subject to damage or removal, whether or not intentional.

Accordingly, there is a need to overcome the issues noted above.

### SUMMARY OF THE PREFERRED EMBODIMENTS

The present invention provides a novel promotional packaging wherein an advertising message contained on a medium such as a printed card is packaged with an enclosure in which a giveaway consumable product is also contained. In one preferred embodiment of the present invention, the advertising message is unrelated to the giveaway consumable product.

It is an object of the present invention to provide a promotional package that includes a consumable item; an enclosure for the item; and an advertising medium having a first surface with a promotional message located thereon. The promotional message is unrelated to the consumable item.

It is also an object of the present invention to provide a method for creating a promotional package. The method including the steps of preparing a consumable item; preparing an advertising medium having a first surface with a promotional message located thereon, wherein the promotional message is unrelated to the consumable item; and placing the consumable item and the advertising medium in a plastic bag. The bag is then sealed to thereby enclose the advertising medium and the food item. In a preferred embodiment the advertising medium is not placed in the bag, but is instead adhered to an outside surface of the bag.

It is yet another object of the present invention to provide a method for selling a multimedia disc. The method includes the steps of preparing an advertising medium that advertises the multimedia disc; preparing a food item; and placing the advertising medium and the food item in a plastic bag. The preferred method further includes the step of vacuum sealing the bag to thereby enclose the advertising medium and the food item.

In accordance with another aspect of the present invention, a method of delivering preferred consumable products to a first person is provided. The method includes the steps of providing the first person with a preference worksheet that includes at least two preference choices, directing the first person to choose at least two preference choices on the preference worksheet, determining at least one consumable product that will fulfill the first person's preferences based on the at least two choices, packaging the at least one consumable product in a first portion of an enclosure, packaging an item having indicia printed on a first surface thereof in a second portion of the enclosure to form a promotional package, and delivering the promotional package to the first person. In a preferred embodiment, the method includes directing the first person to rate substantially all of the preference choices on the preference worksheet.

In accordance with another aspect of the present invention, there is provided a method of providing cookies to a first person. The method includes the steps of providing the first person with an ingredient preference worksheet that includes at least two categories that each include at least two sub-categories, directing the first person to rate substantially all of the sub-categories on the ingredient preference worksheet, determining what types of cookies will fulfill the first person's preferences based on the ratings of the sub-categories, developing a cookie list that includes at least two different types of cookies, preparing the at least two different types of cookies, freezing the at least two different types of cookies, vacuum packaging each cookie in the first portion of a separate bag, placing an item having indicia printed on a first surface thereof into a pouch in each bag, closing the pouches to create a plurality of promotional packages, and delivering the promotional packages to the first person.

Other objects, features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a top plan view of a promotional packaging configured in accordance with a preferred embodiment of the present invention;

FIG. 2 is a perspective exploded view of the promotional packaging of FIG. 1;

FIG. 3 is a bottom plan view of the promotional packaging of FIG. 1;

FIG. 4 is a top plan view of a second promotional packaging configured in accordance with another preferred embodiment of the present invention;

FIG. 5 is a top plan view of a third promotional packaging configured in accordance with another preferred embodiment of the present invention;

FIG. 6 is an exemplary view of an ingredient preference worksheet;

FIG. 7 is flow chart showing the steps for providing a fourth promotional packaging to a consumer in accordance with another preferred embodiment of the present invention;

FIG. 8 is a perspective view of an item being placed into the pouch of the promotional packaging created by the chart of FIG. 7;

FIG. 9 is a front elevational view of the promotional packaging of FIG. 8 after the item has been placed in the pouch;

FIG. 10 is a perspective view of another embodiment of a promotional packaging created by the chart of FIG. 7;

FIG. 11a is a front elevational view of an item being placed into the pouch of a promotional packaging created by the chart of FIG. 7;

FIG. 11b is a front elevational view of the promotional packaging of FIG. 11a after the top has been closed with a closure member; and

FIG. 12 is another front elevational view of a promotional packaging with the top been closed with another closure member.

Like numerals refer to like parts throughout the several views of the drawings.

### DETAILED DESCRIPTION OF THE PREFERRED EMBODIMENTS

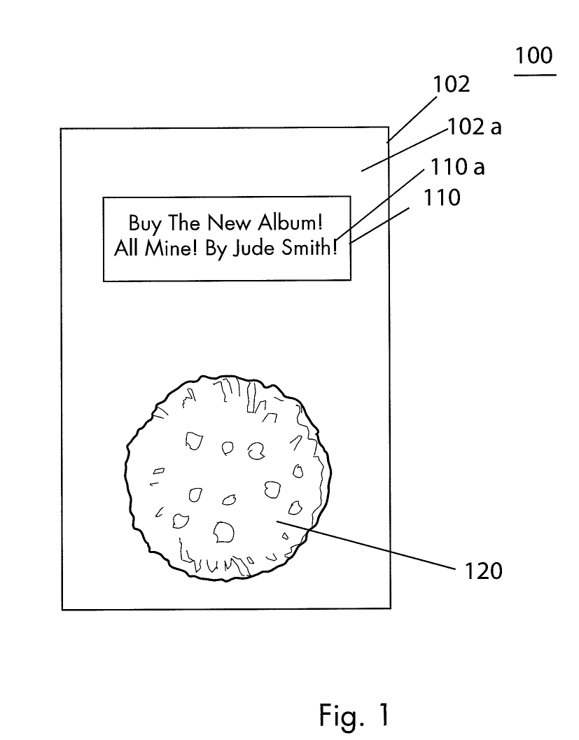

FIG. 1 is a top plan view of a promotional packaging 100 configured in accordance with one preferred embodiment of the present invention, wherein an advertising medium 110 is sealed within an enclosure 102 as a giveaway, or consumable, item/product 120. The advertising medium 110 contains a marketing/advertising or other promotional message that is unrelated to the consumable product 120. For example, as illustrated, the advertising medium 110 is a printed card having a first surface 110a upon which an advertising message—“BUY THE NEW ALBUM: ALL MINE! BY JUDE SMITH!” is printed to promote the sale and distribution of a new album by the artist Jude Smith and the consumable product 120 is a cookie. The advertising message can also be a personal message such as “THANK YOU DR. ESHOM AND STAFF” or “SARAH, I LOVE YOU”, which is also unrelated to the consumable product 120.

In a preferred embodiment, the advertising medium 110 is a printed media. The printed media may be composed of plastic, paper or any other material upon which printing may be achieved. In another preferred embodiment, the advertising medium 110 is a stamped media, such as a plastic stamped card. In yet another preferred embodiment, the advertising medium 110 is a media that has both stamping and printing, such as the stamping and printing that is used for a credit card. In a preferred embodiment, the advertising medium 110 is a business card that may contain a company name, address, telephone number, web address, etc.

In a preferred embodiment, the consumable product 120 is a food item. In another preferable embodiment, the consumable product 120 is a compact disc (CD), a digital video disc (DVD), or other discs containing multimedia (collectively referred to herein as a multimedia disc), as illustrated by a disc in upon which a second advertising or marketing message—“JUDE SMITH ALBUM, TITLED “ALL MINE” TO BE OUT NEXT WEEK,” may be printed. In this preferred embodiment, both top layer 102a and bottom layer 102b of enclosure 102 would include transparent portions through which the advertising or marketing messages provided by the first surface 110a and the second surface 110b of advertising medium 110 may be viewed. In another preferred embodiment, the advertising medium 110 would only include a message on one surface and therefore only one layer of enclosure 102 would need to include a transparent portion. In other preferred embodiments, the consumable product 120 may be one or more other type of products, including but not limited to such type of products as trinkets/jewelry, puzzles, pens/pencils, other food items, etc. Further, the consumable product 120 may have its own packaging or labeling in addition to the packaging described herein. In another embodiment the enclosure 102 can include more than one consumable product 120, such as a mini DVD and a cookie. One consumable product 120 may be related to the advertising message and one may not be. For example, the advertising message may be about the mini DVD and the cookie would be unrelated to the advertising message. Alternatively, both consumable products 120 may be unrelated to the advertising message.

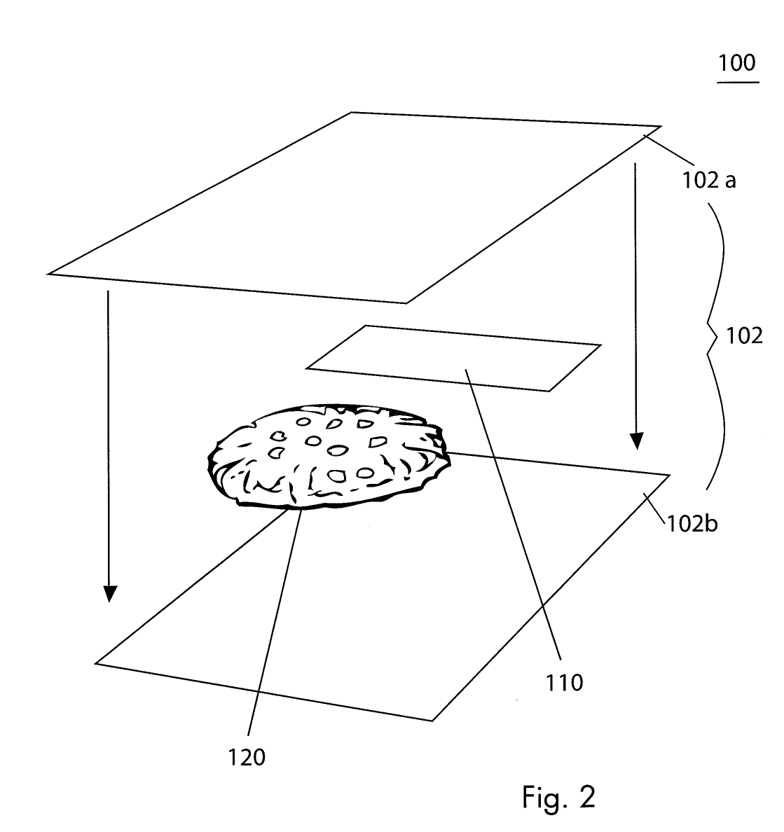

FIG. 2 is an exploded perspective view of the construction of the promotional packaging 100, where it is illustrated that the advertising medium 110 and consumable product 120 is placed on a bottom layer 102b of the promotional packaging 100, and then a top layer 102a of enclosure 102 is then placed on advertising medium 110 and consumable product 120, and attached to bottom layer 102b. In one preferred embodiment, top layer 102a and bottom layer 102b are attached to each other via a heat sealing process, and the advertising medium 110 and the consumable product 120 are vacuums sealed within enclosure 102. In another preferred embodiment, the advertising medium 110 and the consumable product 120 are attached by adhesive to either the top layer 102a or the bottom layer 102b. In yet another preferred embodiment, the advertising medium 110 and the consumable product 120 are contained in separate compartments defined by the attachment locations between the top layer 102a and the bottom layer 102b.

Although the embodiment illustrated in FIG. 1 has the advertising medium 110 being contained in enclosure 102 separately from the consumable product 120, the advertising medium 110 may be in contact with consumable product 120. For example, advertising medium 110 may be a large rigid card or cardboard upon which consumable product 120 rests. The advertising medium 110 may also be of different shapes. Further, multiple advertising media or consumable products may be contained in enclosure 102.

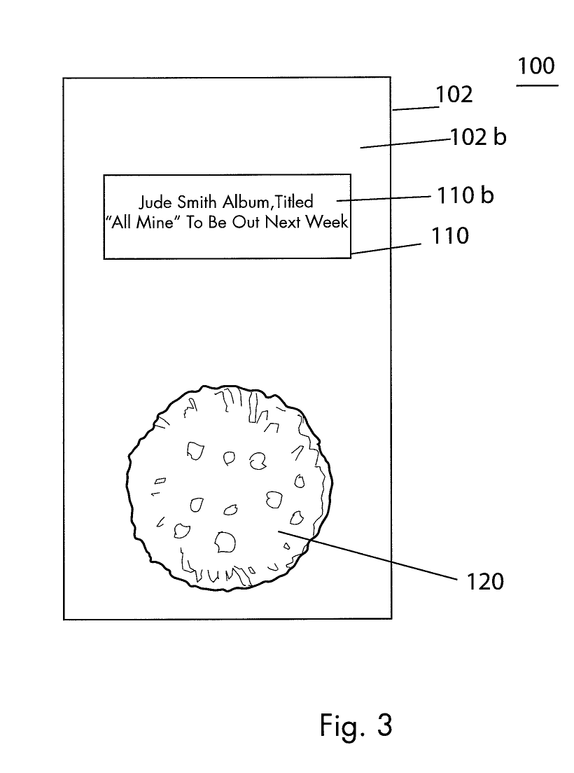

FIG. 3 is a bottom plan view of the promotional packaging 100, where it is illustrated that the advertising medium 110 includes a second surface 110b upon which a second advertising or marketing message—“JUDE SMITH ALBUM, TITLED “ALL MINE” TO BE OUT NEXT WEEK,” may be printed. In this preferred embodiment, both top layer 102a and bottom layer 102b of enclosure 102 would include transparent portions through which the advertising or marketing messages provided by the first surface 110a and the second surface 100b of advertising medium 110 may be viewed. In another preferred embodiment, the advertising medium 110 would only include a message on one surface and therefore only one layer of enclosure 102 would need to include a transparent portion.

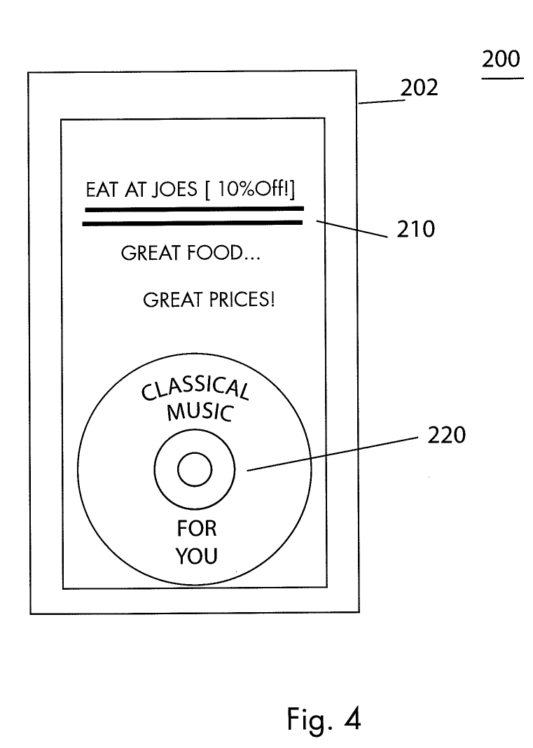

FIG. 4 illustrates a second promotional packaging 200 configured in accordance with another preferred embodiment of the present invention, wherein an enclosure 202 contains an advertising medium 210 upon which is printed the advertisement “EAT AT JOE'S [10% OFF!].” Enclosure 202 also contains a compact disc 220. As illustrated herein, advertising medium 210 is of a size that is large enough to contain a message as well as provide support for compact disc 220. However, as discussed above, the advertising media, such as the advertising medium 110 and the advertising medium 210, used in implementing the present invention do not have to be a specific size or shape. Further, the message presented by the advertising media does not have to be strictly an “advertising” message such as those directed to selling a product, service or event, and may be a message meant to promote a free event, service or product. For example, to promote a hazardous-waste recycling campaign, a city may distribute the promotional packaging 100 with the message printed on the advertising media 110 describing the dangers of keeping hazardous-waste in the household, the benefits of recycling, and locations were hazardous-waste may be dropped off for recycling by the city. Religious groups may also use the promotional packaging to encourage attendance of the groups' services.

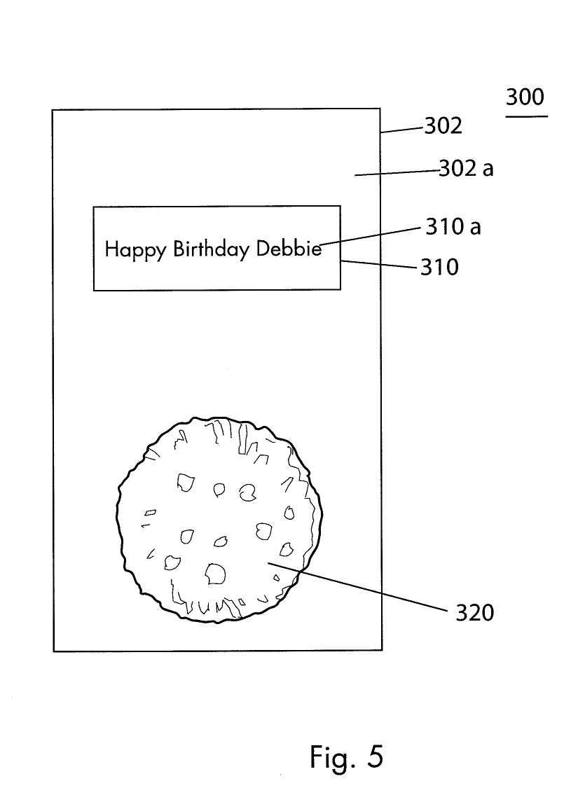

FIG. 5 shows another embodiment of the promotional packaging 300 of the present invention. In this embodiment, the advertising medium 310 is adhered to and outside surface 302a of enclosure 302. This arrangement saves time and money during the manufacturing process. In the above described embodiments, where the advertising medium is inside the enclosure, the entire package is often pre-made (especially when the consumable product 320 is a cookie). In other words, the cookie 320 is sealed in the enclosure 302 before orders are taken from a consumer. If the consumer wants a custom made piece of advertising medium 310, for example, something that has “HAPPY BIRTHDAY DEBBIE” printed on the first surface 310a thereof, the package has to be reopened to put the customized advertising medium 310 inside and then resealed. In this embodiment, the custom made advertising medium 310 can be adhered to the enclosure 302 at any time after the consumable product 320 has been sealed within the enclosure 302. Once again, it should be understood that the slogan, advertising, phone number, etc. on the advertising medium 310 is preferably unrelated to the consumable product 320.

It will be understood that the advertising medium 310 can be adhered to the front 302a, back or both sides of the enclosure 302.

Two of the different embodiments described above, placing the advertising medium on the inside of the enclosure and placing it on the outside of the enclosure may appeal to different markets. For example, by placing the advertising medium inside the enclosure, the consumer can keep the advertising medium. For example, the consumer may take a business card and place it in his pocket for later use. When placing the advertising medium on the outside of the package the consumer will typically throw away the torn open enclosure along with the advertising medium printed thereon.

In another embodiment, the promotional packaging can include more than one consumable product. For example, the package may contain 6 or 8 cookies.

The present invention generally relates to a consumable product and an advertising medium packaged with an enclosure. It will be understood that as used herein, “packaged with” means that the advertising medium is enclosed within or adhered to the outside of the enclosure.

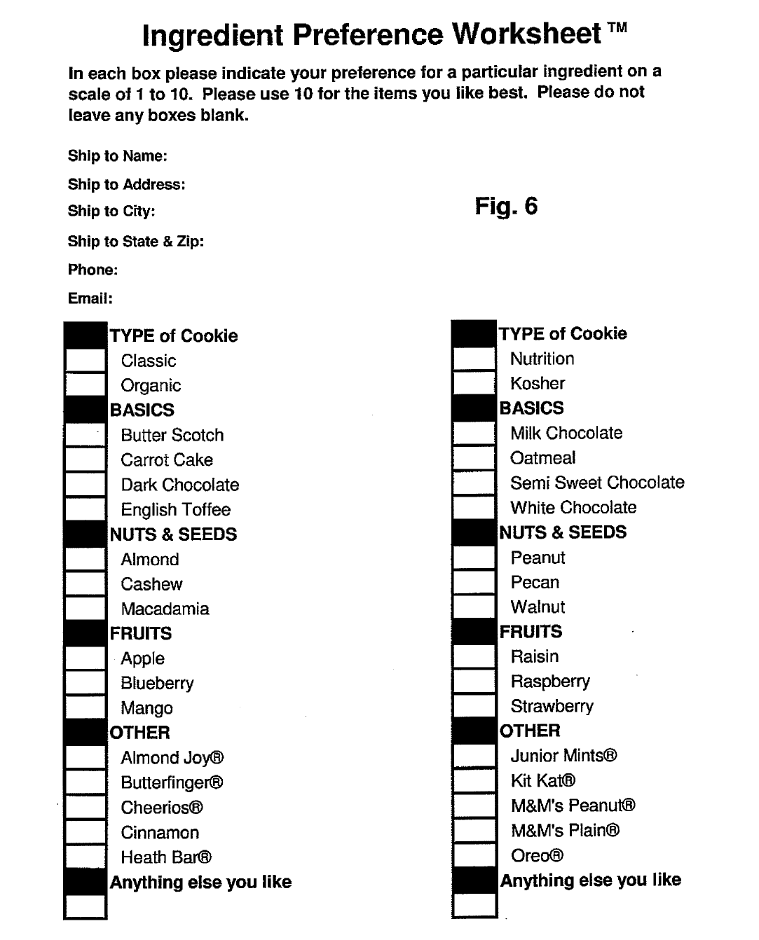

Referring to FIGS. 6-11, another type of and method for producing a promotional package 400 is described. In this embodiment, the consumable product 420 is preferably a cookie. However, it will be understood that other types of consumable products 420 can be included in the enclosure 402 described below. In this embodiment, the cookie ingredients can be chosen by the consumer purchasing the cookie. This can be done using an ingredient preference worksheet (referred to herein as an IPW), a sample of which is shown in FIG. 6. The IPW provides the consumer with the ability to choose only their desired ingredients. That desire may be based on taste, diet, caloric content or the like. For example, cookies can be provided that are vegan, kosher, organic, gluten free, dairy free, gluten and dairy free, sugar free or nutrition-conscious. It will be understood that the IPW shown in FIG. 6 is only exemplary and that it can include many other categories, sub-categories, ingredients, etc.

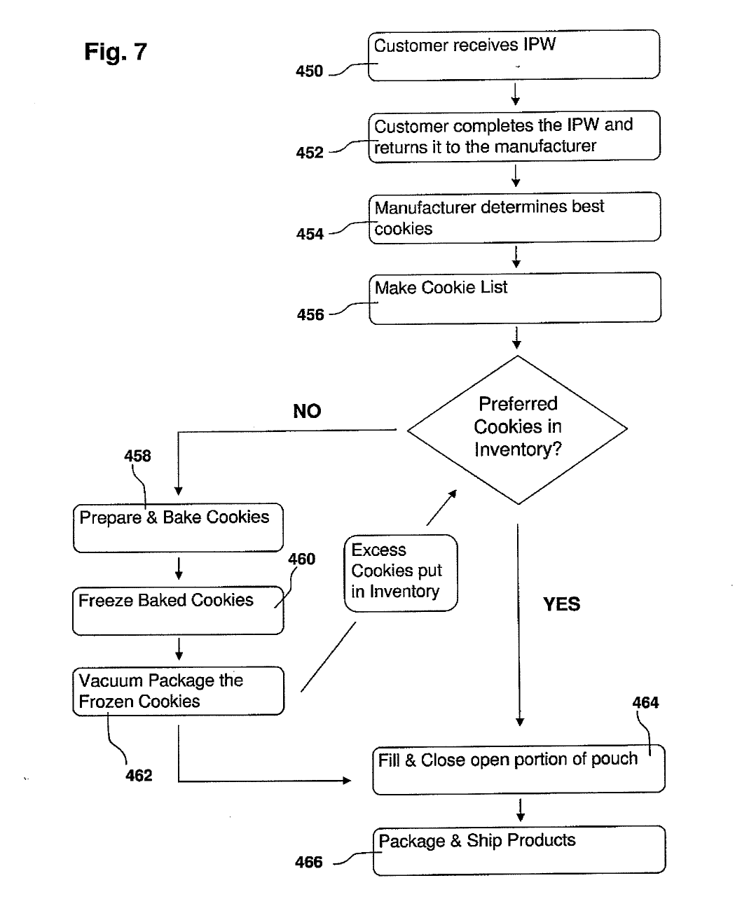

As shown in FIG. 7, the first step in the process is providing the IPW to the consumer (step 450). This can be done by mail, e-mail, a website, in person or any other delivery method. The IPW includes a number of preference choices or categories, such as basics, nuts & seeds, fruits and other, etc. Furthermore, within each category there are further preference choices or sub-categories, for example, specific ingredients within that category, such as dark chocolate, almond, cashew, mango, blueberry, etc. In one embodiment, the consumer can pick the specific ingredients to be used in the cookie. In another embodiment, the consumer can rate the ingredients/preference choices listed on the IPW. For example, as shown in FIG. 6, each ingredient has a blank box next to it where consumers can rate the ingredients using a 10 point scale or the like.

In the embodiment where the ingredients are ranked, after the consumer completes and returns the IPW (step 452) to the cookie manufacturer, the manufacturer determines what type of cookie combinations the consumer would like the best (step 454) based on the ratings of the preference choices. For example, if the consumer ranks classic, English toffee, milk chocolate, raspberry, OREO™ and pecan all as tens and everything else as one, and the consumer has ordered only two cookies, the manufacturer may determine that the consumer would like one classic cookie with raspberries, milk chocolate and pecans and a second classic cookie with milk chocolate, English toffee and OREOS™.

The cookie choices may also be dependent on the number of cookies that the consumer orders. For example, if the same consumer ranked the items as described above, but ordered a hundred cookies, the manufacturer may determine that the consumer would like a hundred classic cookies, twenty with English toffee, twenty with milk chocolate, twenty with raspberries, twenty with OREOS™ and twenty with pecans. In making this determination, the manufacturer creates a cookie list (step 456). It will be understood that in another embodiment, a consumer's order can be filled with only one type of cookie.

After the cookie list has been made, it is sent to an inventory control manager, who determines whether the chosen cookies are in the available inventory or if a new batch is needed to fill any part of the order. Any cookies needed that are not already in inventory are then prepared and baked (step 458). It will be understood by those skilled in the art that the cookies can be prepared in any desired way.

Described below is an exemplary way of preparing and baking the cookies. However, this is not a limitation on the present invention. In this embodiment, the batter for the specific batch is prepared in a batter preparation room. The individual batter components are then sent to the baking room in three separate sealed containers. The first container has the desired amount of the first part of the batch, the second container has the desired amount of the second part of the batch and the third container contains the desired amount of the third part of the batch. For example, in an exemplary embodiment, the first container contains margarine/butter or the like, the second container contains brown sugar, white sugar, salt, flower, oatmeal or any other dry components, and the third container generally includes the ingredients chosen from the IPW. These three containers are then marked as to the batch number and placed on a rack ready to be transported to the baking room.

After transport, in the baking room, the baker takes the batch ingredients in the three containers and starts to prepare the batch. The baker adds fresh eggs if the batter calls for eggs from the egg refrigerator (the egg refrigerator maintains a temperature of about 33° F. to about 38° F.—which is not a limitation on the present invention). The egg refrigerator is located close to the bakers work station so that the eggs are outside of the refrigerator for the shortest possible time.

Once the batch is completed, the dough is placed on cookie sheets. For example, the dough can be placed on 18″ by 26″ commercial cookie sheets which are each lined with Demarle Silpat®, which are non-stick pastry sheets, so that the dough never touches the trays and prevents the cookies from sticking to the pan. This lining is specifically designed to allow the cookies to be removed from the cookie sheets without damaging the cookie. The cookies are then baked at a low temperature for between about 12 minutes and about 40 minutes depending on the type of cookie. The cookies are preferably baked under controlled temperatures to insure consistency. When the cookies are taken out of the oven they are placed on a rack to cool at a temperature of between about 67° F. and about 71° F. They are preferably cooled for about 20 to about 90 minutes depending on humidity and the type of cookie.

The cookies are then placed in a minus 10 degree freezer on the same trays that they were baked in to preserve the integrity of the cookie and frozen for one to four hours depending on the type of cookie (step 460).

After the cookie has completely been frozen it is ready to be vacuum packaged (step 462). In a preferred embodiment, the enclosure 402 in which the cookies are vacuum packaged is a bag. The vacuum packaging settings vary by cookie type however they preferably range between an about 90% and about 94% vacuum if an EVOH bag is used (see below). Those skilled in the art will understand vacuum package settings for other types of bags. In another embodiment, a gas flush may be inserted into the bag to help increase the shelf life of the packaged cookie.

In a preferred embodiment, the frozen cookies are vacuum packed in an EVOH (Ethyl Vinyl Alcohol) vacuum bag. However, this is not a limitation on the present invention. The EVOH bag allows freshly baked cookies to be vacuum packed yet preserve their original shape and form. The EVOH bag is strong, flexible, transparent, and has good oxygen barrier specifications. It is also preferable because EVOH has good chemical resistance including most oils, acids or solvents, good clarity, fragrance preservative properties, good organoleptic properties, is reasonably easy to process, can be extruded with many different polymers during the coextrusion process, and can be reused.

This process preserves freshness and lengthens shelf life without the use of preservatives. In addition, the process protects each cookie from transmittal of germs through handling as each cookie is individually vacuum packed. Therefore, for example, at a party, each cookie is protected from someone handling it and then putting it back on the platter. In a preferred embodiment, each bag has an easy open tear notch for the part of the package that contains the cookie.

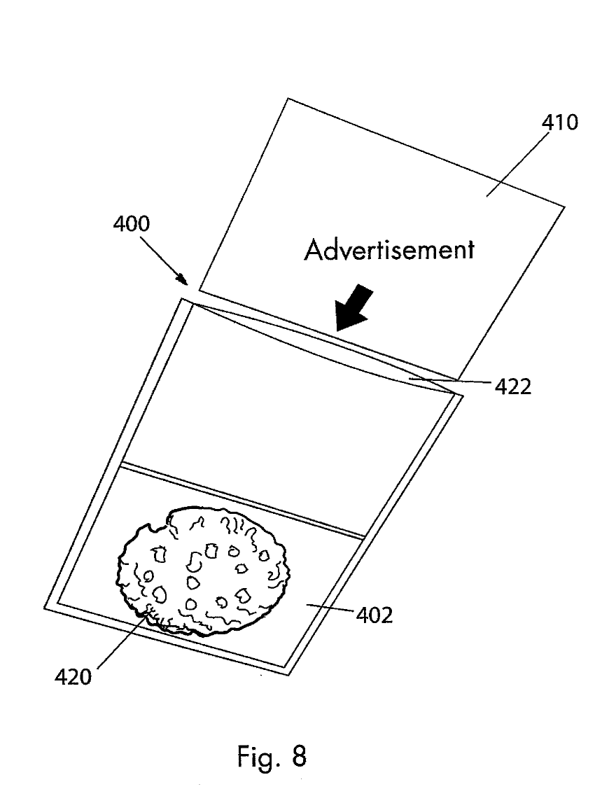

As shown in FIG. 8, after the cookie 420 is vacuum packaged in a portion of the bag 402, the top part of the bag 402 remains open with three sides sealed, thereby creating a pouch 422. The pouch 422 size varies based on the desired package 400 size. For example, in a preferred embodiment, the pouch 422 is about 5.5 inches wide by about 6 inches high. The sizes can be standard from the manufacturer or based on the needs of the consumer.

If excess packages 400 have been created they can be placed in inventory with the top pouch 422 open and available to be filled with the desired item(s).

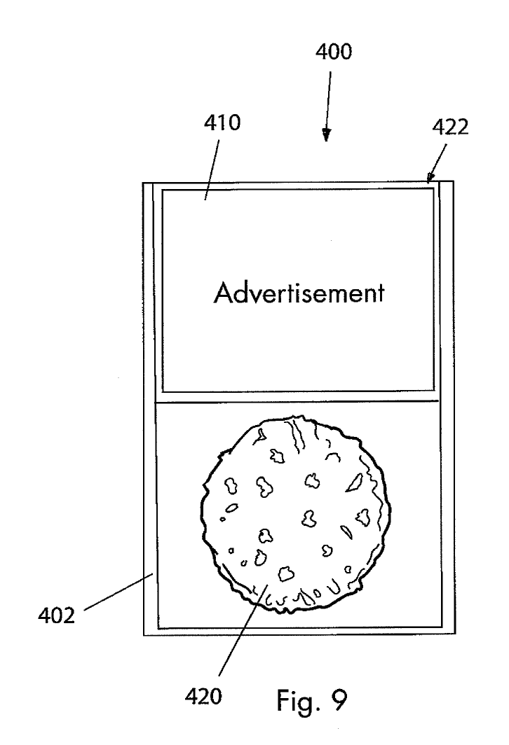

At this point, the manufacturer either takes packages 400 from inventory or packages 400 that have just been made (or a combination of both, depending on the number of cookies ordered) and is ready to fill the pouches 422 with the desired item 410. The desired item 410 may be an advertising medium, business card, confetti, booklet, sticker, gift card, note card or anything else capable of fitting in the pouch 422. Accordingly, as is shown in FIGS. 8 and 9, the item 410 is placed in pouch 422 and the pouch 422 is then closed (step 464).

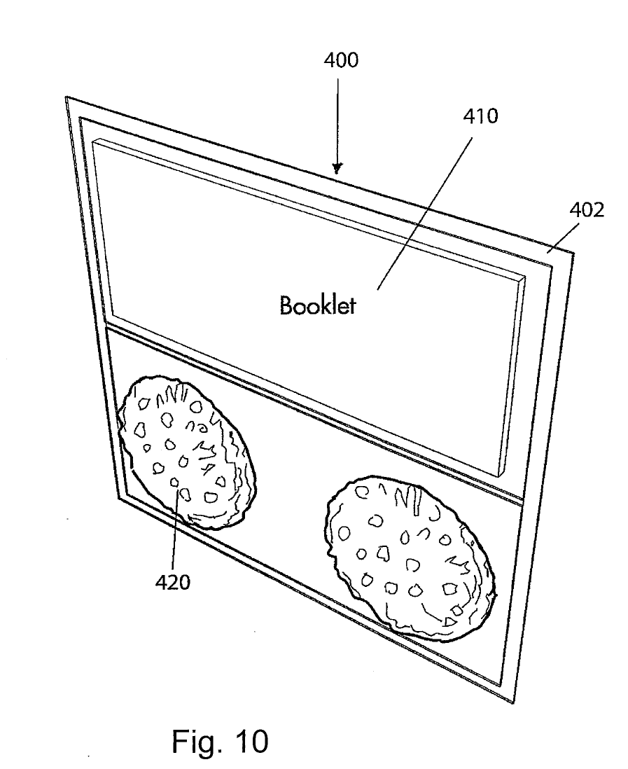

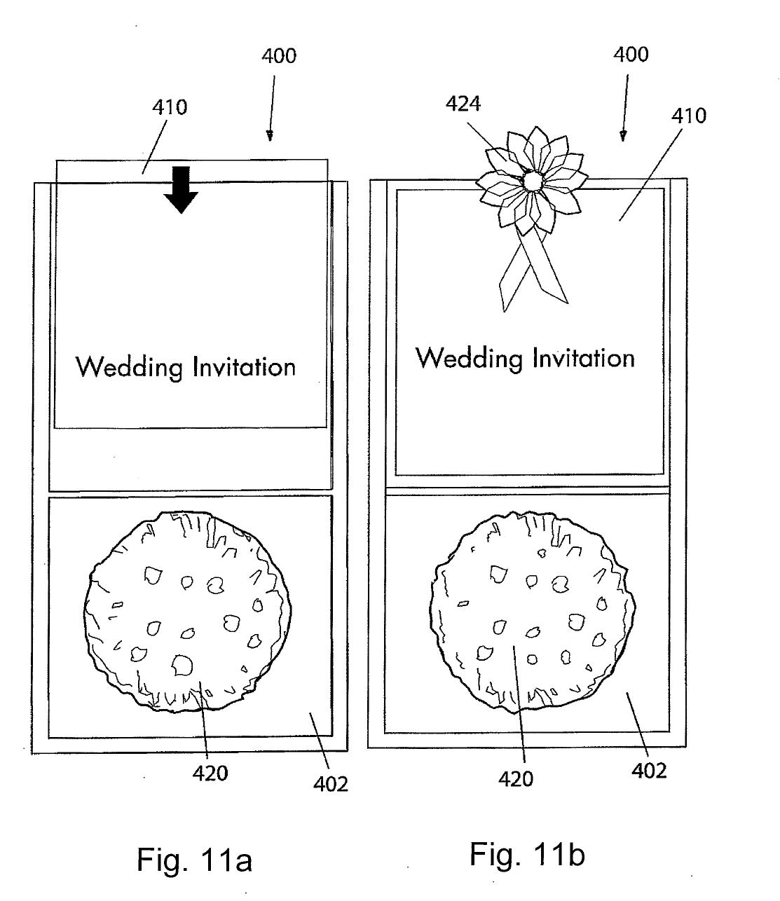

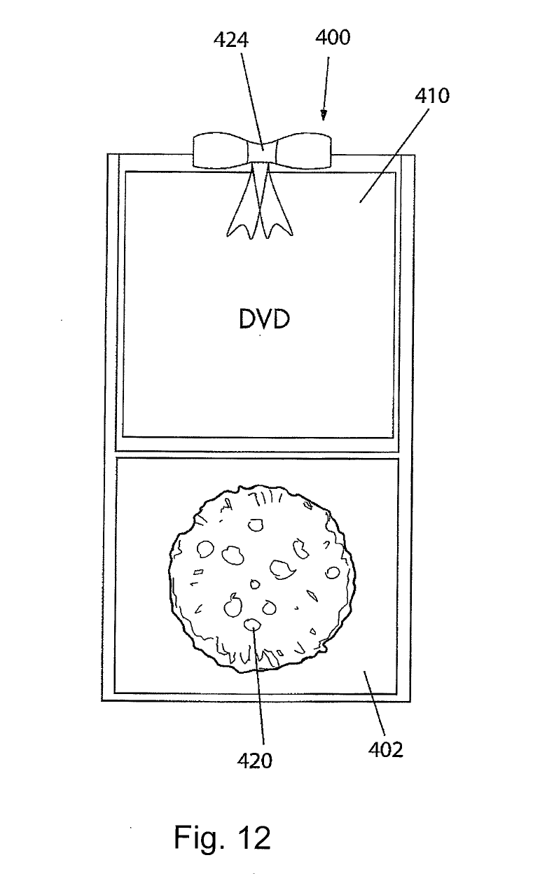

The pouch 422 can be closed in a number of different ways. For example, it can be sealed (e.g., heat sealed), as is shown in FIG. 10, or it may have something that extends across the open top of the pouch 422 that prevents the item 410 from falling out, as is shown in FIGS. 11a-12. Other closure methods are within the scope of the present invention. For example, it may include a zipper, snaps, buttons or may be resealable.

In FIGS. 11a-12, the package 400 includes a closure member 424 that includes wires, ties, wraps, etc., that extend through openings in both sides of the pouch 422 and that are tied on the opposite side, thereby preventing the item 410 from falling out. As shown, the closure members may have designs, such as a bow, flower, etc.

It will be understood that the package 400 can contain any number of consumable products 420 or any other number of items 410 (either in one pouch or separate pouches). For example, as shown in FIG. 10, the package 400 includes two cookies 420 and a booklet 410.

After the pouch 422 is filled and closed, the entire order is packaged and shipped to the consumer (step 466).

In an exemplary embodiment, the consumer may be a company that advertises itself on item 410 and gives the cookies to its clients or employees. Satisfied recipients of a package 400 may then order other packages 400 from the manufacturer with their own custom message.

### Example

A large public company is having its annual shareholder meeting. It places an order for 10,000 promotional packages. The advertising medium 410 portion could read “Welcome to ABC's 2007 Shareholders Meeting” attached with also the line up of speakers and schedule. Intrigued shareholders would simultaneously be enjoying their cookie along with familiarizing themselves with the night's agenda. The manufacturer makes a profit on ABC's order and also reaches out to thousands of potential clients without any advertising.

The embodiments described above are exemplary embodiments of a promotional packaging of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A method of delivering preferred consumable products to a first person, the method comprising the steps of:
(a) providing the first person with a preference worksheet, wherein the preference worksheet includes at least two preference choices,
(b) directing the first person to choose at least two preference choices on the preference worksheet,
(c) determining at least one consumable product that will fulfill the first person's preferences based on the at least two choices,
(d) packaging the foregoing at least one consumable product in a first portion of an enclosure,
(e) packaging an item having indicia printed on a first surface thereof in a second portion of the enclosure, thereby forming a promotional package, and
(f) delivering the promotional package to the first person.

2. The method of claim 1 wherein the choices on the preference worksheet comprise at least two categories, and wherein each of the at least two categories comprise at least two sub-categories.

3. The method of claim 1 wherein step (c) includes determining at least two different consumable products that will fulfill the first person's preferences based on the at least two choices.

4. The method of claim 1 wherein step (b) includes directing the first person to rate substantially all of the preference choices on the preference worksheet.

5. The method of claim 4 wherein the rating is a numerical rating.

6. The method of claim 1 wherein the consumable product is a cookie.

7. The method of claim 1 wherein the at least one consumable product is vacuum packaged in the first portion of the enclosure.

8. The method of claim 1 wherein at least a portion of the indicia printed on the item is unrelated to the consumable product.

9. The method of claim 8 wherein the first person chooses the indicia that is printed on the item.

10. A method of providing cookies to a first person, the method comprising the steps of:
a) providing the first person with an ingredient preference worksheet, wherein the ingredient preference worksheet includes at least two categories, and wherein each of the at least two categories include at least two sub-categories,
b) directing the first person to rate substantially all of the sub-categories on the ingredient preference worksheet,
c) determining what types of cookies will fulfill the first person's preferences based on the ratings of the sub-categories,
d) developing a cookie list based on the determination made in step (c), wherein the cookie list includes at least two different types of cookies,
e) preparing the at least two different types of cookies,
f) freezing the at least two different types of cookies,
g) vacuum packaging each cookie in the first portion of a separate bag, wherein a second portion of each of the bags remains open, thereby creating a pouch in each bag,
h) placing an item having indicia printed on a first surface thereof into each pouch,
i) closing the pouches, thereby creating a plurality of promotional packages, and
j) delivering the promotional packages to the first person.

11. The method of claim 10 wherein at least a portion of the indicia printed on the items is unrelated to the cookie.

12. The method of claim 11 wherein the first person chooses at least a portion of the indicia that is printed on the items.

13. The method of claim 12 wherein the first person provides at least one of the promotional packages to a second person, wherein the second person opens the promotional package, consumes the cookie and retains the item.

14. The method of claim 13 wherein the second person requests an ingredient preference worksheet as a result of retaining the item.

15. The method of claim 12 wherein the item is a card with printing thereon.
